(19) United States
(12) Patent Application Publication
(10) Pub. No.: US 2012/0042589 A1
(43) Pub. Date: Feb. 23, 2012

(54) DOOR FRAME STRUCTURE

(76) Inventor: CHUN-CHEN LIN, Taipei (TW)

(21) Appl. No.: 12/858,447

(22) Filed: Aug. 18, 2010

(51) Int. Cl. E06B 1/04

(52) U.S. Cl. 52/204.1

(57) ABSTRACT

A door frame structure, which includes a plurality of door frame units and locking elements. Each door frame unit has a main body and a door stop, where the door stop is at a surface of the main body. A notch is formed between the main body and the door stop to accommodate a buffer strip. The door frame unit can further include a plurality of set pieces for anchoring to the wall with different thicknesses. The door frame structure of the instant disclosure saves construction labor, improves visual appearance, increases structural stability and adaptability, and reduces door hitting noise.

### BACKGROUND OF INVENTION

1. Field of the Invention

The instant disclosure relates to a door frame structure; in particular, a wall door frame structure.

2. Description of the Related Art

Please refer to FIG. 1. A typical door frame structure 1a includes a main body 11a and a door stop 12a. The main body 11a and the door stop 12a are formed integrally in one piece. One side of the main body 11a has two recesses 111a, and the flip side forms the door stop 12a. A plurality of nails 2a is placed inside the wall 3a, such as a brick wall. One end of the nails 2a sinks into the main body 11a for anchoring the door frame 1a onto the wall 3a. One side of the door stop 12a contacts the door 4a, and each recess 111a holds a coating 5a placing over the surface of the wall 3a.

Next, FIG. 2 shows a different door frame structure 1a. The door frame structure 1a has a door stop slot 112a on one side of the main body 11a. As a separate piece, the door stop 12a has a protrusion 121a. The size of the protrusion 121a matches correspondingly to the door stop slot 112a, allowing the door stop 12a to insert or dislodge from the door stop slot 112a. At the door stop slot 112a, nails can be shot through the main body 11a to anchor the door frame structure 1a onto the wall 3a.

Additional door frame structures are shown in FIGS. 3 and 4. FIG. 3 shows the wall 3a formed by a C-channel 31a. In FIG. 4, the wall 3a is formed by bending a flat bar 32a. Both structures use bolts 2b to secure the door frame structure 1a onto the wall 3a.

Another typical door frame is shown in FIG. 5, where each side of the main body 11a is inserted with a set piece 13a.

The above conventional door frame structures 1 have the following disadvantages. First, nails 2a must be pre-installed prior to anchor the main body 11a onto the wall 3a, which increases the construction time. Second, when nailing the door stop 12a onto the main body 11a, the head of the nails 2a are exposed on the outer surface of the door stop 12a, giving a bad visual appearance. Thirdly, when the door hits the door stop 12a with a significant force, a loud noise is heard.

Based on research and engineering principles, the inventor proposes a solution to address the above issues.

### SUMMARY OF THE INVENTION

The object of the instant disclosure is to provide a door frame structure, which requires less construction labor, improves visual appearance, and reduces the noise by reducing the hitting force of the door to the door stop.

To achieve the above object, the instant disclosure provides a door frame structure comprises a plurality of door frame units. Each door frame unit has a main body and a door stop. A notch is formed in between the door stop and the main body, with a buffer strip inside the notch.

The instant disclosure has the following advantages:
1. No nails need to be pre-installed in saving construction time. Instead, the door frame unit uses locking elements for anchoring to the wall. Also, the door frame unit can be directly installed over the finished floor, with no additional work required. For efficiency, the door frame unit can be easily disassembled.
2. The locking elements are located at the upper portion of the main body near the notch, allowing equal distribution of applied force on the main body in achieving structural stability.
3. Aesthetically, the buffer strip covers over the locking elements, which prevents the locking elements from exposing off the main body for improving visual appearance.
4. When the buffer strip is plugged into the notch, the buffer strip meshes into the exposed portions of the locking elements off the main body in achieving structural stability.
5. The notch accommodates the buffer strip for easing the hitting force from the door to the door stop, which reduces noise.
6. The set piece can be jointed to the main body, and the distance between both set pieces is adjustable based on the wall thickness. No extra work is needed.
7. Aesthetically, the set pieces cover over the locking elements, which prevent the locking elements from exposing off the main body for improving visual appearance.
8. When the set pieces are inserted, the set pieces press against the exposed portions of the locking elements off the main body in achieving structural stability.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a cross-sectional view of a first door frame structure of the prior art.

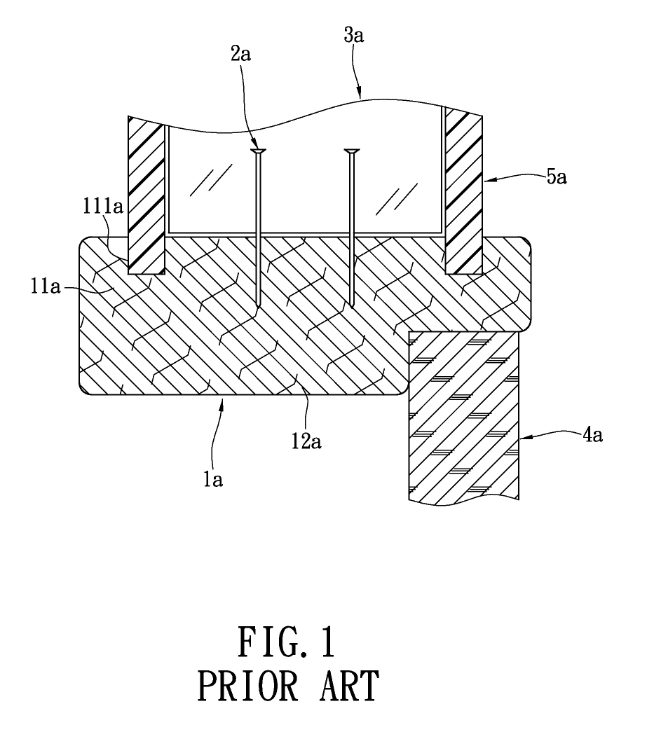

FIG. 2 shows a cross-sectional view of a second door frame structure of the prior art.

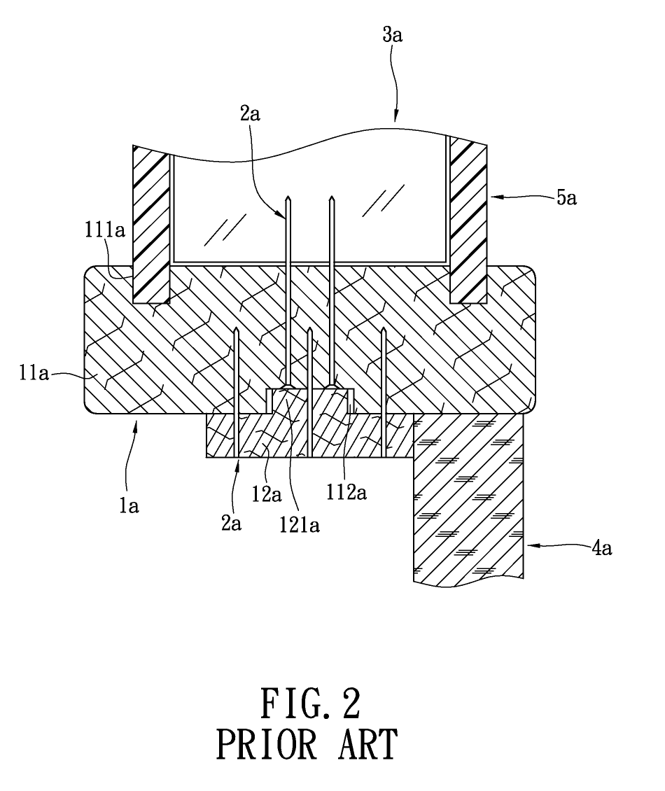

FIG. 3 shows a cross-sectional view of a third door frame structure of the prior art.

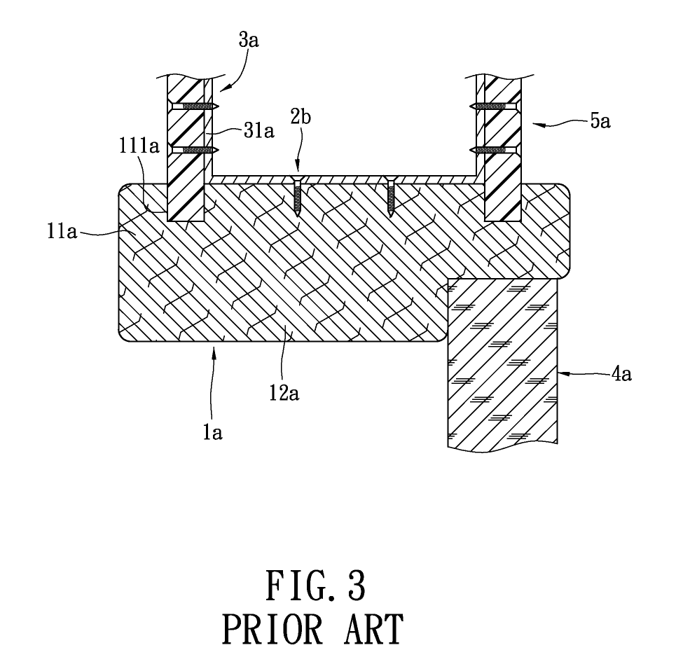

FIG. 4 shows a cross-sectional view of a fourth door frame structure of the prior art.

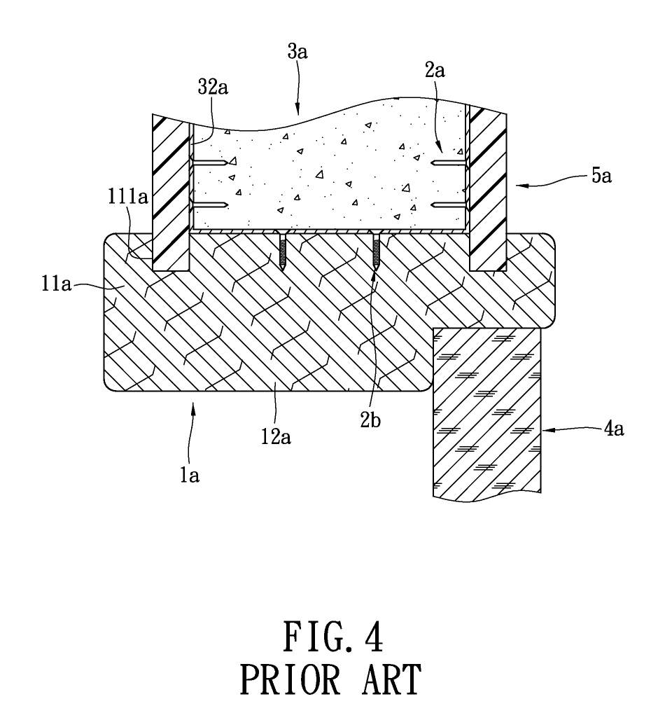

FIG. 5 shows a cross-sectional view of a fifth door frame structure of the prior art.

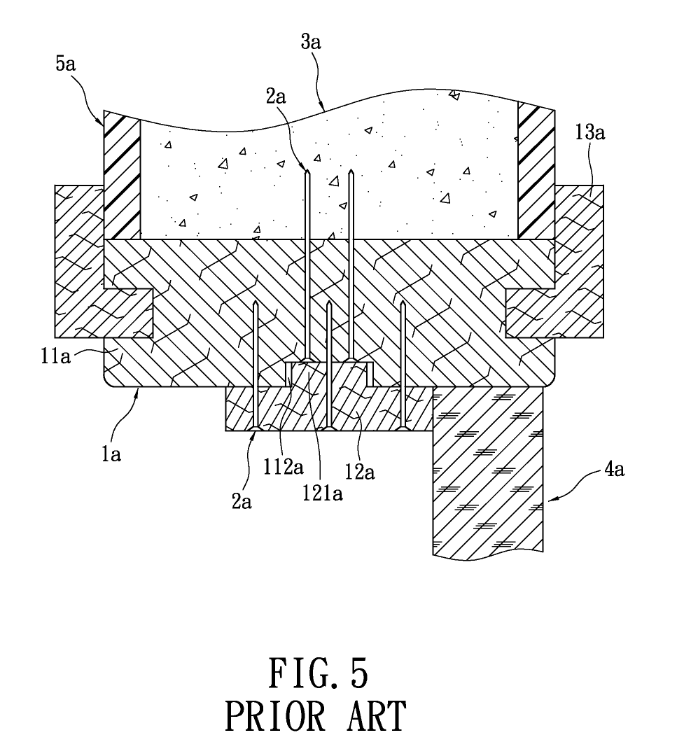

FIG. 6 shows a schematic view of a door frame structure of the instant disclosure.

FIG. 7 shows a cross-sectional view of a door frame structure according to a first embodiment of the instant disclosure.

FIG. 8 shows a cross-sectional view of a door frame structure according to a second embodiment of the instant disclosure.

FIG. 9 shows a cross-sectional view of a door frame structure according to a third embodiment of the instant disclosure.

FIG. 10 shows a cross-sectional view of a door frame structure according to a fourth embodiment of the instant disclosure.

FIG. 11 shows a cross-sectional view of a door frame structure according to a fifth embodiment of the instant disclosure.

FIG. 12 shows a cross-sectional view of a door frame structure according to a sixth embodiment of the instant disclosure.

FIG. 13 shows a cross-sectional view of a door frame structure according to a seventh embodiment of the instant disclosure.

FIG. 14 shows a cross-sectional view of a door frame structure according to an eight embodiment of the instant disclosure.

FIG. 15 shows a cross-sectional view of a door frame structure according to a ninth embodiment of the instant disclosure.

### DETAILED DESCRIPTIONS OF THE PREFERRED EMBODIMENTS

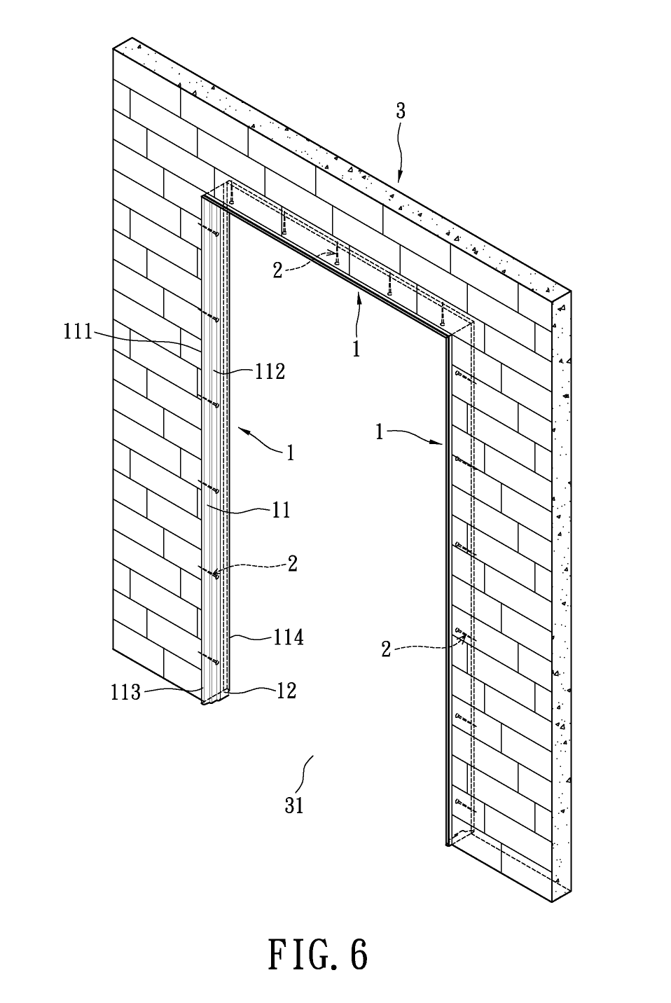

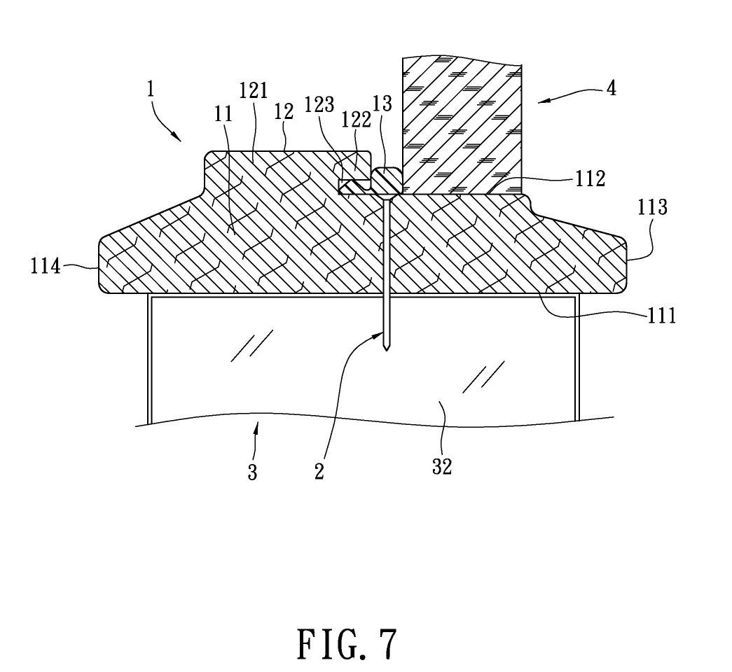

Please refer to FIGS. 6 and 7. The instant disclosure provides a door frame structure having three door frame units 1 and a plurality of locking elements 2. By surrounding about a door opening 31 of a wall 3, the door frame units 1 are connected to each other. In the present embodiment, the wall 3 is a brick wall 32. Next, the plurality of locking elements 2 are used to secure the three door frame units 1 onto the wall 3, followed by assembling a door 4 (shown in FIG. 7).

Each door frame unit 1 has a main body 11 and a door stop 12. The main body 11 has a cylindrical shape, with the size based on the door opening 31. The main body 11 has an outer surface 111, an inner surface 112 opposite of the outer surface 111, a front end surface 113, and a rear end surface 114 opposite of the front end surface 113. Both ends of the outer surface 111 and the inner surface 112 are adjacent to the front end surface 113 and the rear end surface 114. When anchoring the door frame structure to the wall 3, the outer surface 111 of the main body 11 meets the wall 3, and the inner surface 112 faces the door opening 31.

The door stop 12 is located at a surface of the main body 11, namely, the inner surface 112 of the main body 11, where the door stop 12 and the main body 11 are formed integrally in one piece. The door stop 12 has an elevated portion 121 and an overhang 122. The elevated portion 121 protrudes from the main body 11 and extends forward in the direction of the front end surface 113 in forming the overhang 122. The clearance between the door stop 12 and the main body 11 forms a notch 123.

When installing the door 4, one side of the door 4 is pivotally connected to the door frame structure for opening and closing. For a “closed” state (shown in FIG. 7), a buffer strip 13 can be placed inside the notch 123 to ease the hitting force from the door 4 to the door stop 12, which reduces noise.

The plurality of locking elements 2 are spaced evenly along each main body 11. The locking elements 2 can be nails, U-shaped nails, or bolts. The locations of the locking elements 2 are critical for the fastening effect. For the present embodiment, the locking elements 2 are placed near the notch 123 of the main body 11. The locking elements 2 sink through the main body 11 of the door frame unit 1 and into the wall 3, hence securing the main body 11 of the door frame unit 1 to the wall 3. To improve visual appearance for aesthetics, the buffer strip 13 also covers over the locking elements 2, thereby keeping the locking elements 2 from exposing off the surface of the main body 11. Notably, when the buffer strip 13 is plugged into the notch 123, the buffer strip 13 meshes into the exposed portion of the locking elements 12 on the surface of the main body 11. Hence, both the buffer strip 13 and the locking elements 12 are firmly secured on the main body 11.

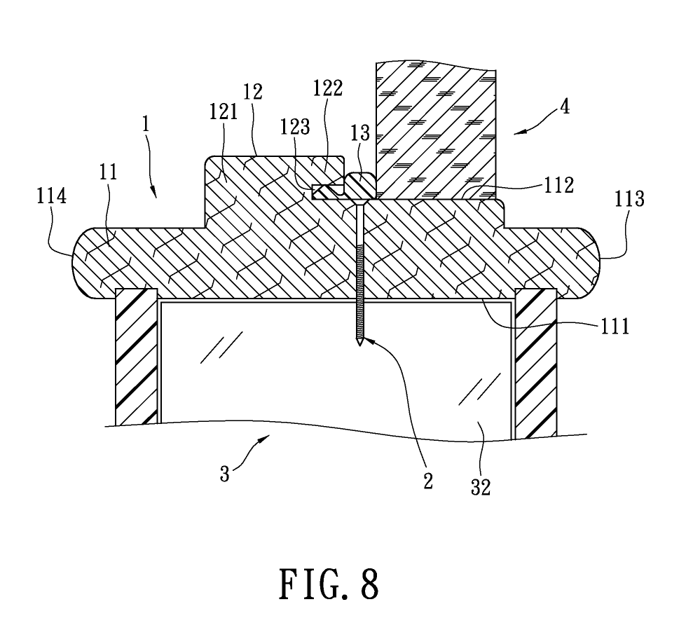

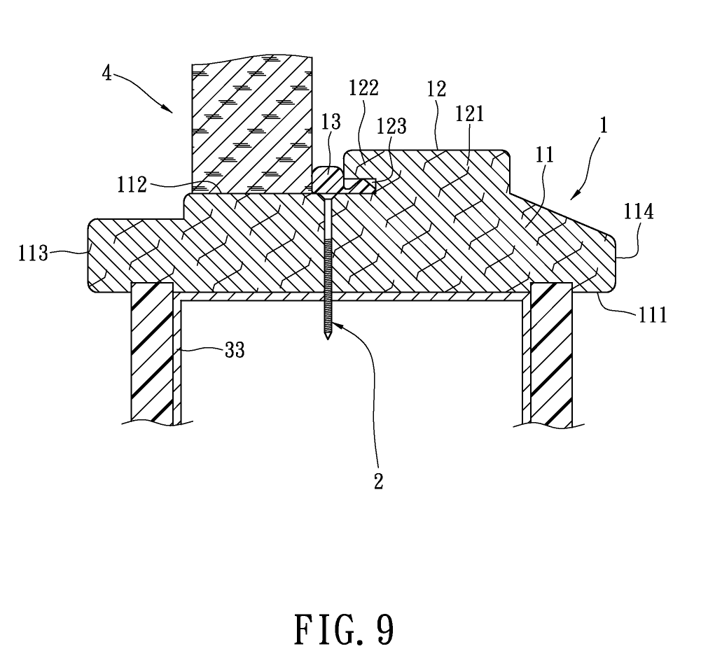

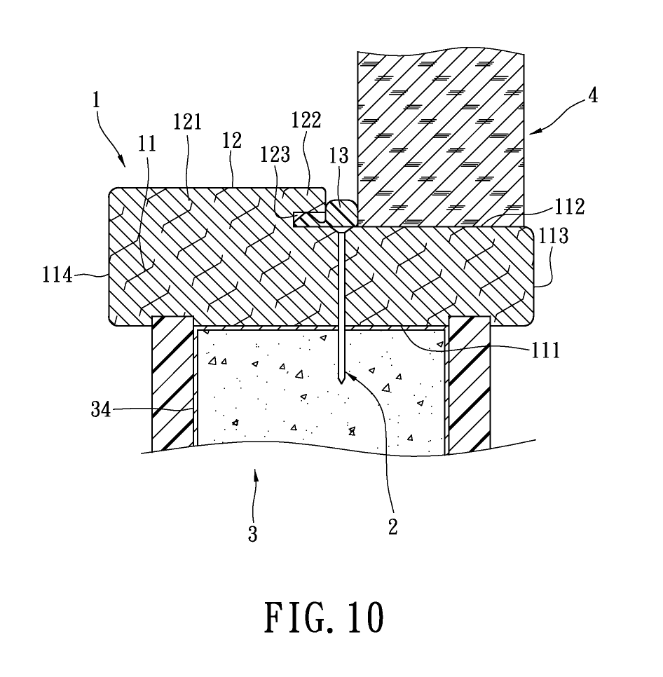

As shown in FIGS. 8 to 10, the door frame unit 1 of the instant disclosure is not restricted physically. The door frame unit 1 can be varied accordingly based on the wall type such as a brick wall 32, a C-channel 33, or by bending of a flat bar 34.

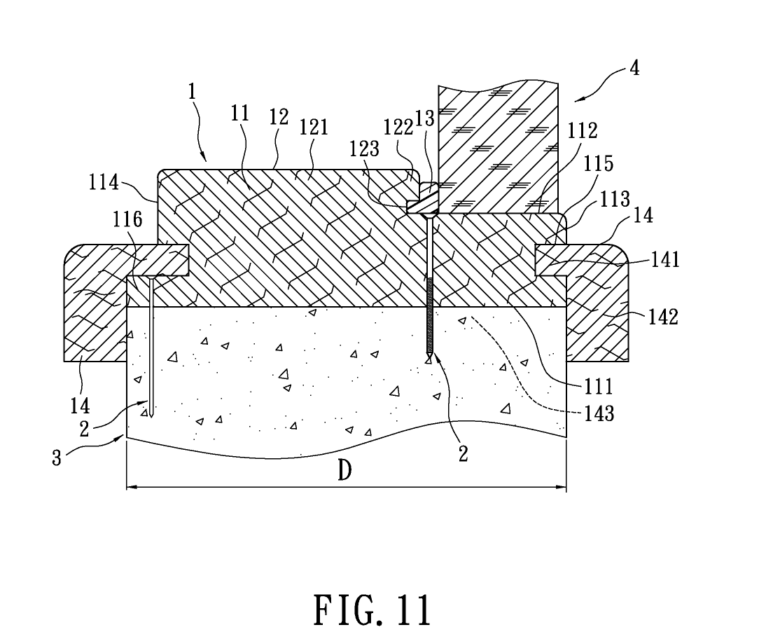

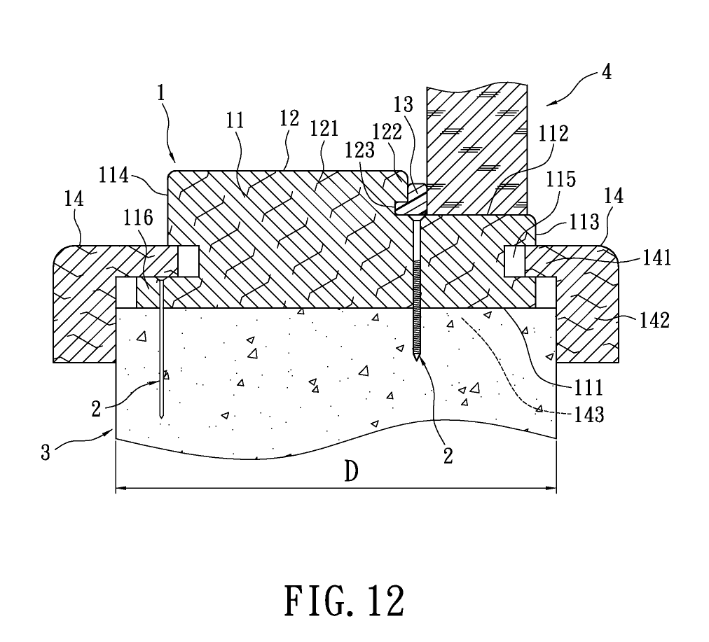

FIGS. 11 and 12 show the door frame unit 1 of the instant disclosure can further comprises two set pieces 14. The front end surface 113 and the rear end surface 114 each has a slot 115 for inserting individual set piece 14. The set piece 14 has an inserting portion 141 and a pressing portion 142. The inserting portion 141 is inserted into the slot 115, and the inserting portion 141 extends toward the outer surface 111 in forming the pressing portion 142. The pressing portion 142 extends beyond the outer surface 111. The space formed by the main body 11 and the two set pieces 14 is defined as a holding slot 143. In addition, an extension 116 is formed off the rear end surface 114 near the outer surface 111. When the door frame structure is anchored to the wall 3, the wall 3 meets the outer surface 111 and is accommodated within the holding slot 143. Since each set piece 14 can be dislodged from the main body 11, the distance D between the two set pieces 14 can be adjusted based on the width of the wall 3. The adjustment allows the pressing portions 142 to maintain a tight hold of the wall 3 in anchoring the main body 11 to the wall 3. As shown in FIG. 12, when the door frame structure is installed to a wider wall 3, the distance D between the two set pieces 14 is widened. In turn, the two set pieces 14 are able to maintain a tight grip to a wider wall 3 for securing the door frame structure. No additional construction labor is needed and work efficiency is increased. Furthermore, the length of the pressing portion 142 can be varied. A longer pressing portion 142 means more contact surface with the wall 3 for enhancing the anchoring effect. The length of the two pressing portions 142 can be the same or different.

The locations of the locking elements 2 are critical for anchoring the door frame structure. The locking elements 2 can be placed at the extension 116 and near the notch 123, where the locking elements 2 sink through the main body 11 and into the wall 3. When the set pieces 14 are inserted into the slots 115, the set pieces 14 presses against the exposed portions of the locking elements 2 off the main body 11 in achieving structural stability. Similarly, when the buffer strip 13 is plugged into the notch 123, the buffer strip 13 meshes into the exposed portions of the locking elements 2 on the main body 11, thus also ensuring structural stability.

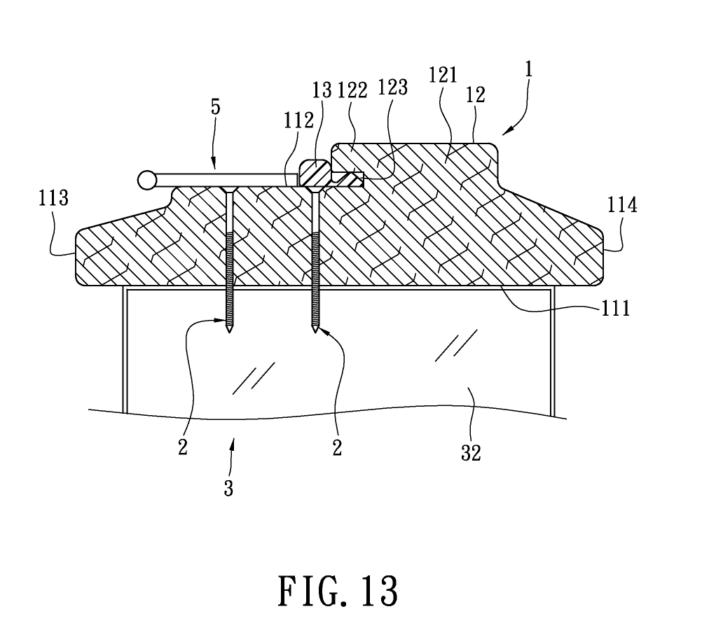

Please refer to FIG. 13. For a larger door frame unit 1, a plurality of locking elements 2 can be placed underneath a hinge 5 of the door frame unit 1, where the hinge 5 is connected pivotally to the door 4. The plurality of locking elements 2 can also be placed underneath a strike plate (not shown). Aesthetically, the hinge 5 and the strike plate provide cover for the locking elements 2 to improve visual appearance. Structurally, the locking elements 2 drive through the main body 11 of the door frame unit 1 and into the wall 3 to provide the fastening effect.

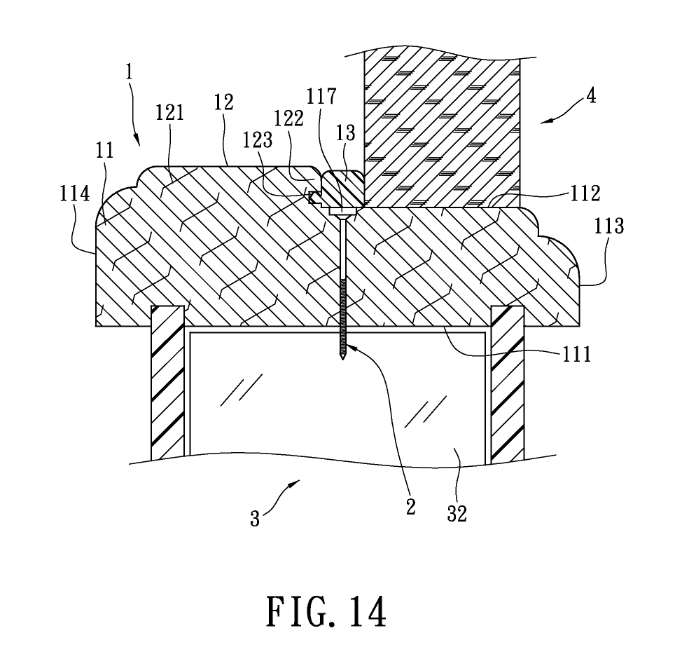

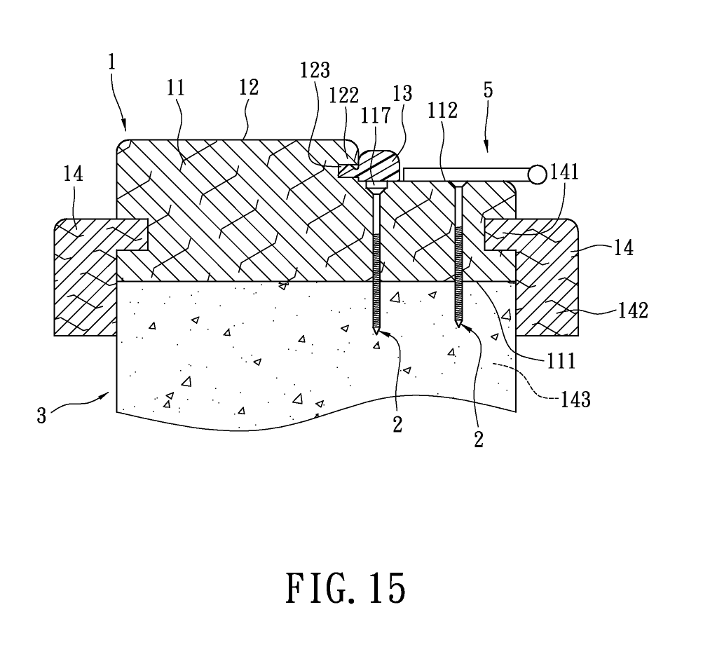

FIG. 14 shows another embodiment of the instant disclosure, where the door frame unit 1 further comprises a set notch 117. The set notch 117 is located at the inner surface 112 near the notch 123. Functionally, the set notch 117 is used to accommodate the locking element 2 for better securing the locking element 2. Similarly, FIG. 15 shows another embodiment of the instant disclosure, where a door frame unit 1 includes a set notch 117 and a hinge 5. A plurality of locking elements 2 can be placed underneath the hinge 5. Aesthetically, the hinge 5 provides a cover for the locking elements 2 for improving visual appearance. Structurally, the locking elements 2 sink through the main body 11 of the door frame unit 1 and into the wall 3 to provide the fastening effect.

Based on the above discussions, the instant disclosure has the following characteristics:
1. The door frame unit 1 can be securely fastened to the wall 3 by the locking elements 2. The door frame unit 1 can be set directly over the finished floor with no extra work needed, and the unit can be disassembled with ease.
2. The door frame unit 1 does not require nails to be pre-installed, which saves construction labor and time.
3. The locking elements 2 are placed close to the center of the main body 11 near the notch 123, allowing equal distribution of the applied force on the main body 11 for better structural stabilization. Aesthetically, the buffer strip 13 is placed over the locking elements 2 to prevent the locking elements 2 from exposing off the main body 11 to improve visual appearance.
4. When the buffer strip 13 is plugged into the notch 123, the buffer strip 13 meshes into the exposed portions of the locking elements 2 off the main body 11 in achieving structural stability.
5. The door frame unit 1 has a notch 123 for holding the buffer strip 13, which eases the hitting force from the door 4 to the door stop 12, thus reducing the noise.
6. The set piece 14 can be individually installed to the main body 11, and the distance D between the two set pieces 14 is adjustable based on the width of the wall 3. No extra construction work is needed.
7. Aesthetically, the set piece 14 covers the exposed portions of the locking elements 2 off the main body 11 for improving visual appearance.
8. When the set pieces 14 are inserted into the slot 115, the set pieces 14 press against the exposed portions of the locking elements 2 off the main body 11 in achieving structural stability.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A door frame structure, comprising:
a plurality of door frame unit, wherein each door frame unit has a main body and a door stop, wherein a notch is formed by the main body and the door stop to accommodate a buffer strip; and
a plurality of locking elements.

2. The door frame structure of claim 1, wherein the door stop has an elevated portion, wherein the elevated portion protrudes off the main body and extends laterally in forming an overhang.

3. The door frame structure of claim 1, wherein each door frame unit is connected to at least one other door frame unit.

4. The door frame structure of claim 3, wherein the locking elements are disposed near the notch of each main body and penetrate through the main body for anchoring the door frame unit; and the buffer strip is disposed over the locking elements.

5. The door frame structure of claim 4, wherein the plurality of locking elements meshes physically with the buffer strip.

6. The door frame structure of claim 4, wherein a set notch is formed near the notch of the main body for receiving the plurality of locking elements.

7. The door frame structure of claim 4, wherein the main body has an extension with a plurality of locking elements.

8. The door frame structure of claim 1, wherein the door frame unit includes a hinge, wherein the hinge is disposed over the locking element.

9. The door frame structure of claim 1, wherein the door frame unit further comprising a plurality of set pieces; and a plurality of slots are formed on the main body for receiving the set pieces.

10. The door frame structure of claim 9, wherein each set piece includes an inserting portion and a pressing portion; the inserting portion is inserted into the slot on the main body; and the pressing portion extends beyond the main body in forming a holding slot.
